(19) United States
(12) Patent Application Publication
(10) Pub. No.: US 2018/0222331 A1
(43) Pub. Date: Aug. 9, 2018

(54) OPTIMIZING CHARGE/DISCHARGE PLANS FOR ELECTRIC VEHICLES

(71) Applicant: Bayerische Motoren Werke Aktiengesellschaft, Muenchen (DE)

(72) Inventor: Caglayan Erdem, Augsburg (DE)

(21) Appl. No.: 15/945,464

(22) Filed: Apr. 4, 2018

Related U.S. Application Data
(63) Continuation of application No. PCT/EP2016/070290, filed on Aug. 29, 2016.

(30) Foreign Application Priority Data
Oct. 5, 2015 (DE) 10 2015 219 202.4

(51) Int. Cl. B60L 11/18; G06Q 50/06; G06Q 10/04; H02J 7/00

(52) U.S. Cl. CPC B60L 11/184; H02J 7/007; G06Q 10/04; G06Q 50/06

(57) ABSTRACT

A method for determining a charge plan for an electrical energy store of a vehicle includes subdividing a charging time interval, which is available for charging the energy store, into a sequence of time segments, such that constant charging power conditions are respectively present in the time segments in the sequence of time segments. For each time segment in the sequence of time segments, a limited number of possible charging powers with which the energy store can be charged and/or discharged in the respective time segment are determined. A plurality of sequences of charging points are determined, where each of the charging points indicates a charging power from the limited number of possible charging powers for a given time segment from the sequence of time segments, and where each sequence of charging points from the plurality of sequences of charging points indicates a sequence of charging powers for the sequence of time segments. A sequence of charging points from the plurality of sequences of charging points is then selected as the charge plan.

### CROSS REFERENCE TO RELATED APPLICATIONS

This application is a continuation of PCT International Application No. PCT/EP2016/070290, filed Aug. 29, 2016, which claims priority under 35 U.S.C. § 119 from German Patent Application No. 10 2015 219 202.4, filed Oct. 5, 2015, the entire disclosures of which are herein expressly incorporated by reference.

### BACKGROUND AND SUMMARY OF THE INVENTION

The invention relates to a method and a corresponding control unit for determining charge plans and/or discharge plans for electric vehicles.

A household may comprise a multiplicity of electrical consumers and one or more sources of electrical energy (for example a solar installation and/or an electrical home connection to a supply network). The household may also comprise one or more electrical energy stores which appear as a consumer when they are being charged and appear as a source when they are being discharged. These various components of a household can be centrally controlled via an HEMS (Home Energy Management System) in order to optimize the electrical energy consumption according to particular criteria (for example in order to minimize the costs of electrical energy).

An electric vehicle comprises an electrical energy store which can be charged (and therefore appears as a consumer) and/or can be discharged (and therefore appears as a source) via a charging apparatus in a household. In this case, an electric vehicle is typically connected to the charging apparatus over a relatively long charging time interval (for example from an evening to the following morning). There is therefore typically a relatively long period available for bringing the charge of the energy store of the electric vehicle to a particular level (that is to say to a particular SOC, State of Charge).

The present document deals with the technical object of efficiently determining a charge plan for an electric vehicle, in particular a charge plan which reduces (in particular minimizes) a predefined cost criterion. In this case, one or more time segments in which the electric vehicle is discharged at a charging station are also possibly intended to be determined within the scope of the charge plan. It is therefore possible to determine a combined charge/discharge plan for an electric vehicle. Extended cost criteria can be taken into account by enabling one or more discharging time segments.

One aspect describes a method for determining a charge plan for an electrical energy store of a vehicle. In this case, the electrical energy store can also be occasionally discharged within the scope of the charge plan. It is therefore possible to determine a combined charge plan having one or more charging time segments and one or more discharging time segments. The method comprises subdividing a charging time interval, which is available overall for charging the energy store, into a sequence of time segments. In this case, the subdivision is preferably carried out in such a manner that constant charging power conditions are respectively present in the time segments in the sequence of time segments. The charging power conditions may comprise a maximum charging power which can be provided by a charging apparatus at a particular time for the purpose of charging the energy store and/or a maximum discharging power which can be delivered to the charging apparatus by the energy store at a particular time. Alternatively or additionally, the charging power conditions may comprise (positive or negative) energy costs which arise (typically as positive costs) at a particular time for charging the energy store and/or which arise (typically as negative costs) at a particular time when discharging the energy store.

The method also comprises determining, for each time segment in the sequence of time segments, a limited number of possible charging powers with which the energy store can be charged and/or discharged in the respective time segment. In this case, the process of determining the limited number of possible charging powers may comprise dividing a charging power interval into N possible charging powers, where N may be less than or equal to 10 (for example 5). Values of N of greater than 10 are possibly also conceivable. The charging power interval may have an upper limit defined by a charging power which can be provided at most by the charging apparatus (for example as a result of a technical limitation). Negative charging powers may also possibly be enabled in this case (for occasionally discharging the energy store).

A limited number of possible charging powers can therefore be respectively defined for a limited number of time segments. It is thus possible to define a network having a limited number of charging points for a limited number of time segments. In this case, a charging point for a time segment indicates a charging power from the limited number of possible (positive or negative) charging powers for this time segment. The problem of determining an (optimum) charge plan can therefore be formulated as the problem of determining an (optimum) path through the network of charging points (that is to say a sequence of charging points).

The method also comprises determining a multiplicity of sequences of charging points. In this case, a sequence of charging points indicates a sequence of charging powers for the corresponding sequence of time segments. In other words, a sequence of charging points indicates the (constant) charging powers with which the energy store is intended to be charged in the various time segments in the sequence of time segments. In this case, the multiplicity of sequences of charging points can be determined in a particularly efficient and precise manner by means of dynamic programming, in particular by means of a Viterbi algorithm. A sequence of charging points can then be selected from the multiplicity of sequences of charging points as the charge plan for charging the energy store.

The abovementioned method, in particular the temporal division into time segments and/or the division into a limited number of possible charging powers, makes it possible to efficiently determine charge plans.

A charging point for a time segment can indicate (positive or negative) costs which are caused by the charging and/or discharging with the (positive or negative) charging power indicated by the charging point. These costs can be determined, for example, on the basis of the energy costs in the time segment and on the basis of the charging power of the charging point. The process of determining a multiplicity of sequences of charging points may comprise determining, on the basis of the costs indicated by the charging points, a multiplicity of cumulative costs for the corresponding multiplicity of sequences of charging points. The sequence of charging points for the charge plan can then be selected on the basis of the multiplicity of cumulative costs. It is therefore possible to select a charge plan which minimizes the cumulative costs.

The multiplicity of sequences of charging points can be determined iteratively, time segment by time segment, starting from a starting time segment and/or starting from an end time segment in the sequence of time segments. In particular, the process of determining a multiplicity of sequences of charging points may comprise: for a first time segment in the sequence of time segments, determining M subsequences of charging points running from the starting time segment or from the end time segment to a second time segment which adjoins the first time segment. In this case, M may be, for example, 20, 10 or less. On the basis of the charging points for the first time segment and on the basis of the M subsequences of charging points, it is then possible to determine extended subsequences of charging points which run from the starting time segment or from the end time segment to the first time segment. The multiplicity of sequences of charging points can therefore be determined iteratively, time segment by time segment. The computational effort for determining the multiplicity of sequences of charging points can be limited as a result of the limitation to a limited number M of subsequences of charging points.

The process of determining a multiplicity of sequences of charging points may comprise: determining M cumulative partial costs for the M subsequences of charging points for the first time segment in the sequence of time segments. On the basis of the charging points for the first time segment and on the basis of the M cumulative partial costs, it is then possible to determine cumulative partial costs for the extended subsequences of charging points. Furthermore, a subset of the extended subsequences of charging points (for example M extended subsequences of charging points) can be selected on the basis of the cumulative partial costs for the extended subsequences of charging points. In particular, a limited subset having the lowest cumulative partial costs can be selected. A cost-optimized charge plan can therefore still be provided with limited computational effort.

The method may also comprise determining transition costs for a transition from a charging point in the second time segment to a charging point in the first time segment. In this case, the transition costs may depend, in particular, on costs of changing the charging power (as a result of the transition between the charging points). The cumulative partial costs for the extended subsequences of charging points can then also be determined on the basis of the transition costs. Costs which are caused by changing the charging power can thus be efficiently taken into account.

The method may also comprise checking whether a first extended subsequence of charging points satisfies a secondary condition, in particular with respect to an amount of energy provided overall by the extended subsequence of charging points. The first extended subsequence of charging points can be rejected if the secondary condition has not been satisfied. Charge plans which do not satisfy the required secondary conditions (for example a required SOC at the end of the charging time interval) can therefore be rejected at an early time. The computational effort can therefore be reduced further.

Another aspect describes a control unit which is set up to carry out the abovementioned method.

Another aspect describes a software (SW) program. The SW program can be set up to be executed on a processor and to thereby carry out the method described in this document.

Another aspect describes a storage medium. The storage medium may comprise an SW program which is set up to be executed on a processor and to thereby carry out the method described in this document.

It should be noted that the methods, apparatuses and systems described in this document can be used both alone and in combination with other methods, apparatuses and systems described in this document. Furthermore, any aspects of the methods, apparatuses and systems described in this document can be combined with one another in various ways. In particular, the features of the claims can be combined with one another in various ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a block diagram of an exemplary system for charging an electric vehicle;

FIG. 2a shows an exemplary temporal profile of maximum charging powers which are available for charging the electric vehicle, and an exemplary temporal profile of the energy costs;

FIG. 2b shows an exemplary gradient curve which indicates significant changes in the maximum charging powers and/or the energy costs;

FIG. 2c shows an exemplary division of a charging time interval into time segments and exemplary possible charging powers;

FIG. 3 shows exemplary sequences of charging points; and

FIG. 4 shows a flowchart of an exemplary method for determining a charge plan.

### DETAILED DESCRIPTION OF THE DRAWINGS

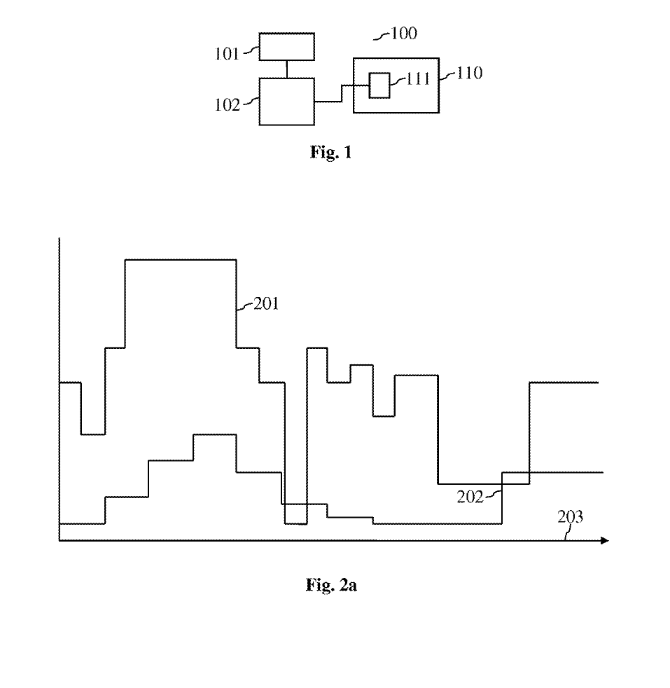

As explained at the outset, the present document deals with the determination of a charge plan for an electric vehicle. FIG. 1 shows a block diagram for a system 100 for charging an electric vehicle 110. The vehicle 110 comprises an electrical energy store 111 which is set up to provide electrical energy for operating an electrical drive machine of the vehicle 110. The energy store 111 may be connected to a charging apparatus 102 for receiving electrical energy. The system 100 comprises a control unit 101 which is set up to control the charging operation of the energy store 111. In particular, the control unit 101 is set up to determine a charge plan for charging the energy store 111 and to charge the energy store 111 on the basis of the charge plan.

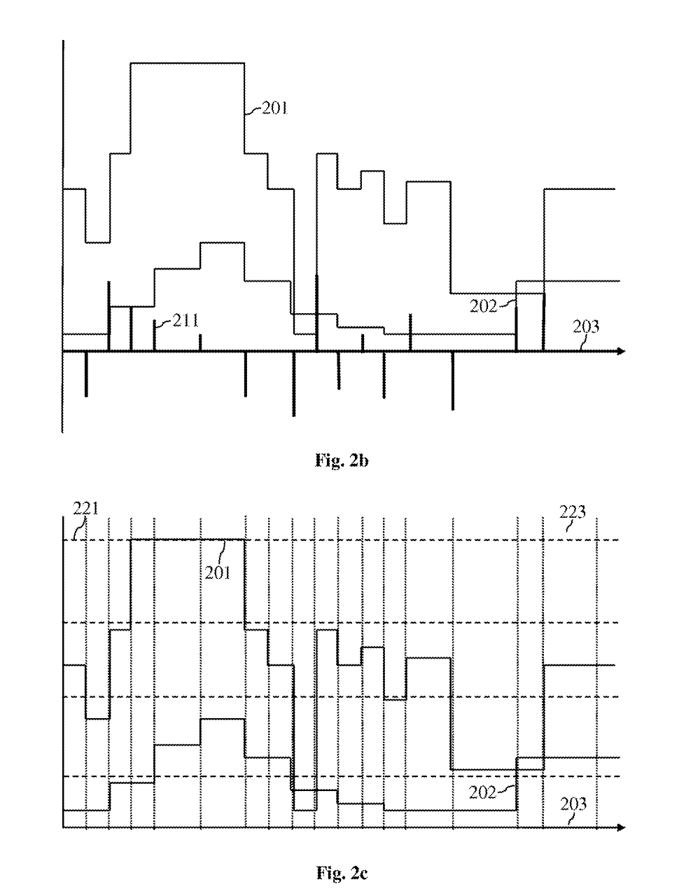

Different maximum charging powers 201 (see FIG. 2a) are typically available at different times for charging the energy store 111. The maximum charging power 201 available for charging may vary, for example, on account of the temporal availability of energy sources (for example solar energy) and/or on account of the different demand for electrical energy from different electrical consumers. FIG. 2a shows an exemplary profile of the maximum charging power 201 over time 203. FIG. 2a also shows an exemplary profile of the energy costs over time 203. The energy costs may vary, for example, on account of the different composition of the available electrical energy. For example, the energy costs may be lower if solar energy is available than if the electrical energy is obtained via a public supply network.

The intention is now to determine a charge plan for the energy store 111 of the vehicle 110, which ensures that the energy store 111 has a predefined state (in particular SOC) at the end of a charging time interval. The intention is also to determine a charge plan which reduces (in particular minimizes) the costs.

For this purpose, a sequence of time segments in which the charging power conditions are substantially constant can be determined for the available charging time interval. Exemplary charging power conditions are the abovementioned maximum charging power 201 and the abovementioned energy costs 202 in a particular time segment. In particular, it is therefore possible to determine a sequence of time segments in which the maximum charging power 201 and the energy costs 202 are constant. For this purpose, the profile of the maximum charging power 201 and the profile of the energy costs 202 can be used to determine a gradient curve 211 which indicates times at which at least one charging power condition changes. These times can be considered to be boundaries between adjacent time segments.

FIG. 2c shows exemplary time segments 223 for the profiles of the maximum charging power 201 and of the energy costs 202 from FIG. 2a. The charging power conditions are constant within a time segment 223. These time segments 223 can be used as the temporal resolution for determining a cost-optimal charge plan. The complexity of the optimization problem for determining a charge plan can therefore be reduced.

The charging time interval can therefore be subdivided into a sequence of time segments 223, the charging power conditions being constant in each time segment 223. For each time segment 223, it is also possible to define different possible charging powers 221 with which the energy store 111 can be charged in the respective time segment 223. 5 different charging powers 221 between 0 kW and the maximum possible charging power (for example 0 kW, 1.1 kW, 3.2 kW, 5.3 kW and 7.4 kW) are defined in FIG. 2c.

The energy store 111 can therefore be charged with different charging powers 221 in a time segment 223. For each time segment 223, it is therefore possible to define different amounts of energy which can be supplied to the energy store 111 in the respective time segment 223. In this case, the amounts of energy result from the charging power 221 and from the temporal length of a time segment 223.

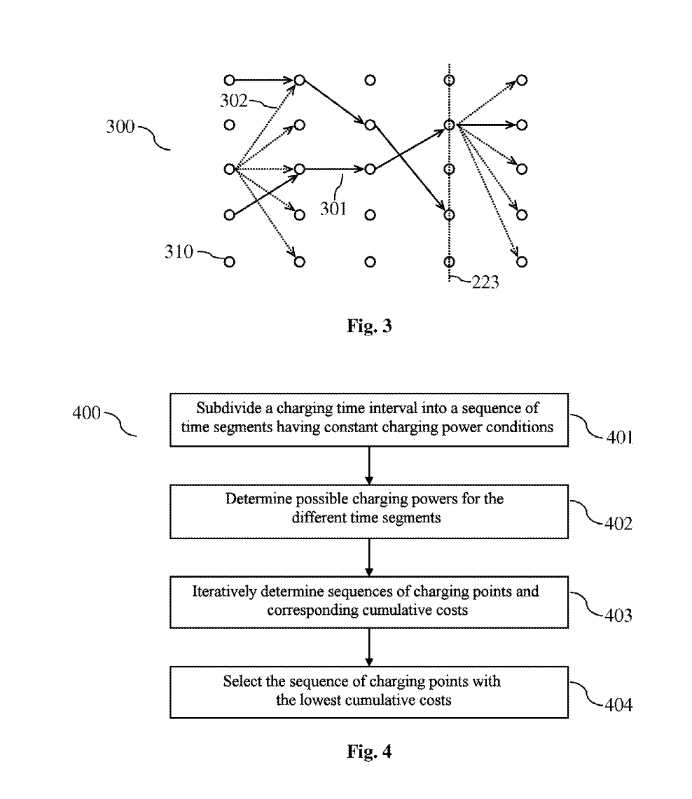

FIG. 3 shows a network 300 of charging points 310. The network 300 comprises a multiplicity of charging points 310 for a time segment 223, a charging point 310 having one or more charging point parameters. The charging point parameters may comprise:

the amount of energy transmitted to the energy store 111 in the time segment 223 of the charging point 310;

the charging power 221 with which charging is carried out in the time segment 223 of the charging point 310; and/or

the energy costs associated with the transmitted amount of energy.

The network 300 also comprises transitions 302 (illustrated by means of dotted or solid arrows) from a first charging point 310 (in a first time segment 223) to a second charging point 310 (in a second time segment 223 directly following the first time). The transitions 302 may comprise one or more transition parameters. The transition parameters may comprise, for example, costs of changing the charging power.

It is therefore possible to provide a network 300 which defines possible charging powers for the charging operation and associated costs. A path 301, that is to say a temporal sequence of charging points 310, through the network 300 can then be found, which path reduces (possibly minimizes) a predefined cost criterion comprising, for example, the cumulative energy costs of the charging operation. The path 301 is illustrated by means of the solid arrows in FIG. 3. In this case, a dynamic programming method, in particular a Viterbi algorithm, can be efficiently used.

In particular, starting from the charging points 310 for a starting time segment 223 in the sequence of time segments 223 for example, a path 310 of charging points 310 to an end time segment 223 in the sequence of time segments 223 can be iteratively determined. In order to reduce the computational effort, a limited number of partial paths can be selected in this case in each iteration step (that is to say for each time segment 223 in the sequence of time segments 223). Only the limited number of partial paths is then taken into account for the further method. Furthermore, paths which do not satisfy a predefined secondary condition can be excluded early (for example paths which do not reach or exceed the total amount of energy to be received by the energy store 111 during the charging time interval).

FIG. 4 shows a flowchart of an exemplary method 400 for determining a charge plan for an electrical energy store 111 of a vehicle 110. The method 400 comprises subdividing 401 a charging time interval, which is available for charging the energy store 111, into a sequence of time segments 223, with the result that constant charging power conditions are respectively present in the time segments 223 in the sequence of time segments 223. The method 400 also comprises determining 402, for each time segment 223 in the sequence of time segments 223, a limited number of possible charging powers 221 with which the energy store 111 can be charged in the respective time segment 223. The method 400 also comprises determining 403 a multiplicity of sequences of charging points 310. In this case, a charging point 310 for a time segment 223 indicates a charging power from the limited number of possible charging powers for this time segment 223. A sequence of charging points 310 also indicates a sequence of charging powers for the sequence of time segments 223. The method 400 also comprises selecting 404 a sequence of charging points 310 from the multiplicity of sequences of charging points 310 as the charge plan.

In particular, it is possible to use parameterized dynamic programming with special suitability assessment for meaningfully possible temporal combinations of charging powers in order to determine a cost-optimal charge plan.

The costs of the electrical energy for operating a vehicle and a household can be minimized by means of the method described in this document. Furthermore, a degree of autonomy can be increased by specifically using local energy sources. The charging efficiency of electric vehicles can also be increased. If necessary, the optimization by means of suitable parameterization may simultaneously take into account a plurality of levels: load management and energy management. The method described in this document is scalable and can therefore be additionally used for fleet charging optimization.

The present invention is not restricted to the exemplary embodiments shown. In particular, it should be noted that the description and the figures are intended to illustrate only the principle of the proposed methods, apparatuses and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining a charge plan for an electrical energy store of a vehicle, the method comprising the acts of:
subdividing a charging time interval, which is available for charging the energy store, into a sequence of time segments, such that constant charging power conditions are respectively present in the time segments in the sequence of time segments;
determining, for each time segment in the sequence of time segments, a limited number of possible charging powers with which the energy store can be charged and/or discharged in the respective time segment;
determining a plurality of sequences of charging points, wherein each of the charging points indicates a charging power from the limited number of possible charging powers for a given time segment from the sequence of time segments, and wherein each sequence of charging points from the plurality of sequences of charging points indicates a sequence of charging powers for the sequence of time segments; and
selecting a sequence of charging points from the plurality of sequences of charging points as the charge plan.

2. The method as claimed in claim 1, wherein the plurality of sequences of charging points are determined by dynamic programming.

3. The method as claimed in claim 2, wherein the plurality of sequences of charging points are determined by a Viterbi algorithm.

4. The method as claimed in claim 1,
wherein each of the charging points further indicates costs which are caused by the charging and/or discharging with the charging power indicated by the respective charging point;
wherein determining the plurality of sequences of charging points comprises determining, based on the costs indicated by the charging points, a plurality of cumulative costs for the corresponding plurality of sequences of charging points; and
wherein selecting the sequence of charging points for the charge plan comprises selecting the sequence of charging points from the plurality of sequences of charging points as the charge plan based on the plurality of cumulative costs.

5. The method as claimed in claim 2,
wherein each of the charging points further indicates costs which are caused by the charging and/or discharging with the charging power indicated by the respective charging point;
wherein determining the plurality of sequences of charging points comprising determining, based on the costs indicated by the charging points, a plurality of cumulative costs for the corresponding plurality of sequences of charging points; and
wherein selecting the sequence of charging points for the charge plan comprises selecting the sequence of charging points from the plurality of sequences of charging points as the charge plan based on the plurality of cumulative costs.

6. The method as claimed in claim 4, wherein determining the plurality of sequences of charging points comprises, for a first time segment in the sequence of time segments,
determining M subsequences of charging points running from a starting time segment or from an end time segment to a second time segment which adjoins the first time segment; and
determining, based on the charging points for the first time segment and on the M subsequences of charging points, extended subsequences of charging points which run from the starting time segment or from the end time segment to the first time segment.

7. The method as claimed in claim 5, wherein determining the plurality of sequences of charging points comprises, for a first time segment in the sequence of time segments,
determining M subsequences of charging points running from a starting time segment or from an end time segment to a second time segment which adjoins the first time segment; and
determining, based on the charging points for the first time segment and on the M subsequences of charging points, extended subsequences of charging points which run from the starting time segment or from the end time segment to the first time segment.

8. The method as claimed in claim 6, further comprising the acts of:
determining M cumulative partial costs for the M subsequences of charging points;
determining, based on the charging points for the first time segment and on the M cumulative partial costs, cumulative partial costs for the extended subsequences of charging points; and
selecting a subset of the extended subsequences of charging points based on the cumulative partial costs for the extended subsequences of charging points.

9. The method as claimed in claim 7, further comprising the acts of:
determining M cumulative partial costs for the M subsequences of charging points;
determining, based on the charging points for the first time segment and on the M cumulative partial costs, cumulative partial costs for the extended subsequences of charging points; and
selecting a subset of the extended subsequences of charging points based on the cumulative partial costs for the extended subsequences of charging points.

10. The method as claimed in claim 8, further comprising the act of:
determining transition costs for a transition from a charging point in the second time segment to a charging point in the first time segment,
wherein the cumulative partial costs for the extended subsequences of charging points are also determined based on the transition costs, and
wherein the transition costs depend on costs of changing the charging power.

11. The method as claimed in claim 9, further comprising the act of:
determining transition costs for a transition from a charging point in the second time segment to a charging point in the first time segment,
wherein the cumulative partial costs for the extended subsequences of charging points are also determined based on the transition costs, and
wherein the transition costs depend on costs of changing the charging power.

12. The method as claimed in claim 8, further comprising the acts of:
checking whether a first extended subsequence of charging points satisfies a secondary condition with respect to an amount of energy provided by the extended subsequence of charging points; and
rejecting the first extended subsequence of charging points if the secondary condition has not been satisfied.

13. The method as claimed in claim 10, further comprising the acts of:
checking whether a first extended subsequence of charging points satisfies a secondary condition with respect to an amount of energy provided by the extended subsequence of charging points; and
rejecting the first extended subsequence of charging points if the secondary condition has not been satisfied.

14. The method as claimed in claim 1, wherein the plurality of sequences of charging points are determined iteratively, time segment by time segment, starting from at least one of a starting time segment and an end time segment in the sequence of time segments.

15. The method as claimed in claim 1, wherein determining the limited number of possible charging powers comprises dividing a charging power interval into N possible charging powers,
wherein the charging power interval is limited by a charging power which can be provided at most by a charging apparatus, and
wherein N is less than or equal to 10.

16. The method as claimed in claim 1, wherein the charging power conditions comprise at least one of:
a maximum charging power which can be provided by a charging apparatus at a particular time for the purpose of charging the energy store,
a maximum discharging power which can be made available to the charging apparatus at a particular time for the purpose of discharging the energy store, and
energy costs which arise at a particular time for charging and/or discharging the energy store.
